(19) United States
(12) Patent Application Publication
(10) Pub. No.: US 2014/0260899 A1
(43) Pub. Date: Sep. 18, 2014

(54) METHOD AND APPARATUS FOR DESCRIBING AND RESTORING JUNGGANBO

(71) Applicant: Electronics and Telecommunications Research Institute, Daejeon (KR)

(72) Inventors: Yong Ju LEE, Daejeon (KR); Keun Woo CHOI, Seoul (KR); Tae Jin PARK, Seoul (KR); Kyeong Ok KANG, Daejeon (KR)

(73) Assignee: Electronics and Telecommunications Research Institute, Daejeon (KR)

(21) Appl. No.: 14/157,627

(22) Filed: Jan. 17, 2014

(30) Foreign Application Priority Data
Mar. 13, 2013 (KR) 10-2013-0026669
May 21, 2013 (KR) 10-2013-0056919

(51) Int. Cl. G10G 1/04

(52) U.S. Cl. CPC G10G 1/04
USPC 84/453

(57) ABSTRACT

Provided is a method and apparatus for describing and restoring a jungganbo, the method of describing a jungganbo including analyzing a structure of the jungganbo based on gaks, daegangs, and junggans constituting the jungganbo, and generating jungganbo structure data describing the structure of the jungganbo, based on a result of the analyzing.

### CROSS-REFERENCE TO RELATED APPLICATIONS

This application claims the benefit of Korean Patent Application No. 10-2013-0026669, filed on Mar. 13, 2013, and Korean Patent Application No. 10-2013-0056919, filed on May 21, 2013, in the Korean Intellectual Property Office, the disclosures of which are incorporated herein by reference.

### BACKGROUND

1. Field of the Invention

The present invention relates to a method and apparatus for describing and restoring a jungganbo, and more particularly, to a method and apparatus for describing and restoring a jungganbo that may arrange a structure of gaks, daegangs, and junggans constituting a jungganbo and store the jungganbo as an extensible markup language (XML) based digital file.

2. Description of the Related Art

Every country has traditional music and a traditional scheme of expressing such traditional music. In Korean traditional music, various score writing schemes were used for periods. One of the Korean traditional score writing schemes is a jungganbo, which was invented by King Sejong and is still in use today.

However, since the Western staff was introduced to Korea, the staff has been frequently used for Korean traditional music, rather than a jungganbo. The staff is used for Korean traditional music for various reasons, and one of the reasons is that there are a few basic programs for a jungganbo.

There are programs for writing scores on a staff and such programs are widely used throughout the world. The programs may include, for example, Finale, Sibelius, Logic, LilyPond, Cubase, and the like. In the past, the compatibility among such score writing programs was not guaranteed. However, the programs have recently supported scores written based on the Music extensible markup language (MusicXML) standard. Accordingly, an issue of the compatibility has been resolved greatly.

A representative commercial jungganbo writing tool for writing a jungganbo is Jungganbo Mania. However, due to an inconvenience of use, the majority of Korean traditional music majors are using word processors being text editors to write jungganbos.

Research on a method of writing a jungganbo readily is being conducted to continuously to alleviate issues occurring during a process of digitalizing a jungganbo. In particular, various research, for example, research on a method of writing a jungganbo through interoperation with Musical Instrument digital Interface (MIDI), research on a method of describing a jungganbo in an XML, research on a jungganbo input system, and the like, are being conducted. However, such research is not utilized properly due to a limited scope of the research, a difficulty in maintenance and management, and the like.

Programs for writing jungganbos have not been developed actively because there are no standards on a scheme of writing jungganbos. With respect to a staff, standards for converting a staff to a digitalized score, for example, Music markup language (MusicML), MusicXML, and the like have been established, a compatibility with MIDI, virtual Studio Technology (VST), and the like is supported, and a scope of application of the staff is being expanded. However, with respect to a jungganbo, standards for storing scores in a digital files format are yet to be defined.

Accordingly, in order to invigorate jungganbo writing programs, there is a demand for advance definition and standardization with respect to a method of digitalizing and storing a jungganbo.

### SUMMARY

An aspect of the present invention provides a method of describing a jungganbo that may store, in a digital file format, the jungganbo including various symbols expressing sounds of the jungganbo and a structure of gaks, daegangs, and junggans constituting the jungganbo, thereby describing the jungganbo using less capacity and enabling the jungganbo to be utilized in various environments.

Another aspect of the present invention also provides a method of describing a jungganbo that may include various types of symbols and structures of the jungganbo, by analyzing the symbols and the structures of the jungganbo to store the jungganbo as a digital file using an extensible markup language (XML).

According to an aspect of the present invention, there is provided a method of describing a jungganbo, the method including analyzing a structure of the jungganbo based on gaks, daegangs, and junggans constituting the jungganbo, and generating jungganbo structure data describing the structure of the jungganbo, based on a result of the analyzing.

According to another aspect of the present invention, there is provided a method of restoring a jungganbo, the method including identifying a structure of the jungganbo by analyzing jungganbo structure data describing the structure of the jungganbo, and restoring the jungganbo based on the identified structure of the jungganbo. The jungganbo structure data may express a structure of gaks, daegangs, and junggans constituting the jungganbo.

According to still another aspect of the present invention, there is provided an apparatus for describing a jungganbo, the apparatus including an analyzer to analyze a structure of the jungganbo based on gaks, daegangs, and junggans constituting the jungganbo, and a generator to generate jungganbo structure data describing the structure of the jungganbo, based on a result of the analyzing.

According to yet another aspect of the present invention, there is provided an apparatus for restoring a jungganbo, the apparatus may include an identifier to identify a structure of the jungganbo by analyzing jungganbo structure data describing the structure of the jungganbo, and a restorer to restore the jungganbo based on the identified structure of the jungganbo. The jungganbo structure data may express a structure of gaks, daegangs, and junggans constituting the jungganbo.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an overall structure for writing a jungganbo according to an embodiment of the present invention;

FIG. 2 is a block diagram illustrating an apparatus for describing a jungganbo according to an embodiment of the present invention;

FIG. 3 is a block diagram illustrating an apparatus for restoring a jungganbo according to an embodiment of the present invention;

FIG. 4 is a diagram illustrating bujunggans according to an embodiment of the present invention;

FIG. 5 is a flowchart illustrating a method of describing a jungganbo according to an embodiment of the present invention; and

FIG. 6 is a flowchart a method of restoring a jungganbo according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Herein, the term “daegang” is also referred to as “gang”, and the term “junggan” is also referred to as “jung”.

FIG. 1 is a diagram illustrating an overall structure for writing a jungganbo according to an embodiment of the present invention.

Referring to FIG. 1, an apparatus 101 for describing a jungganbo may include gaks, daegangs, and junggans constituting a jungganbo 102. The jungganbo 102 refers to a score expressing time values, and may be used in Korean and the Orient. A time value refers to a length of sound expressed by a note or a rest, and may express a relative time length. In this instance, the apparatus 101 for describing a jungganbo may analyze a structure of the jungganbo 102 based on gaks, daegangs, and junggans constituting the jungganbo 102.

In particular, the apparatus 101 for describing a jungganbo may analyze a number of the gaks constituting the jungganbo 102, a number of daegangs included in each gak, and a number of junggans included in each daegang. Here, a gak refers to a column of the jungganbo 102. A single gak includes at least one daegang, and a single daegang includes at least one junggan. For example, the apparatus 101 for describing a jungganbo may include four gaks constituting the jungganbo 102, and one of the four gaks includes two daegangs.

One of the two daegangs includes four junggans which express a beat of the jungganbo 102. In this instance, a junggan is a basic unit of a jungganbo. The junggan expresses a beat of the jungganbo 102, and a single junggan basically corresponds to a single beat. In addition, the junggan may be divided into multiple beats based on beats to be expressed. The multiple divided beats are referred to as bujunggans. The bujunggans may include respective symbols in each junggan. The symbols refer to symbols used for expressing sounds of the jungganbo 102, and may include a yulmyung, a jangsikbuho, a jansikum, an expression sign, a jubeop, an unjibeop, a space, and the like.

In particular, the apparatus 101 for describing a jungganbo may analyze the gaks, the daegangs, and the junggans constituting the jungganbo 102 to determine components to be included in a jungganbo 104. The apparatus 101 for describing a jungganbo may generate jungganbo structure data describing the structure of the jungganbo 104 based on a result of analyzing the structure of the jungganbo 102 with respect to a number of the determined gaks, a number of the determined daegangs, and a number of the determined junggans. More particularly, the apparatus 101 for describing a jungganbo may arrange attributes of symbols included in junggans and the structure of the jungganbo 102 constituting each jungganbo 104, based on the plurality of jungganbos 104. In this example, the jungganbo structure data refers to a digital file described in an extensible markup language (XML). The apparatus 101 for describing a jungganbo may generate the jungganbo structure data based on a result of analyzing the structure of the jungganbo 102, thereby readily describing and storing the jungganbo 104 using less capacity.

The apparatus 101 for describing a jungganbo may interoperate with an apparatus 103 for restoring a jungganbo. The apparatus 103 for restoring a jungganbo may restore the jungganbo 104 in which the structure of the jungganbo 102 is described. The apparatus 103 for restoring a jungganbo may analyze a structure of the jungganbo 104 described in the jungganbo structure data, from the jungganbo structure data generated by the apparatus 101 for describing a jungganbo. The apparatus 103 for restoring a jungganbo may identify the structure of the jungganbo 104 based on a result of the analyzing. In this example, a digital file may be extracted through software for analyzing the jungganbo 104 or a user desiring to restore the jungganbo 104. In the digital file, the structure of the jungganbo 104 and symbols included in junggans, and the like may be analyzed by the user or the jungganbo extraction software. The apparatus 103 for restoring a jungganbo may restore the jungganbo 104 based on the identified structure of the jungganbo 104.

FIG. 2 is a block diagram illustrating an apparatus 201 for describing a jungganbo according to an embodiment of the present invention.

Referring to FIG. 2, the apparatus 201 for describing a jungganbo may include analyzer 202 and a generator 203.

The analyzer 202 may analyze a structure of a jungganbo based on gaks, daegangs, and junggans constituting the jungganbo. In particular, the analyzer 202 may analyze the structure of the jungganbo to determine a number of gaks of the jungganbo to be included in a digital file, a number of daegangs included in each gak, and a number of junggans included in each daegang.

The analyzer 202 may analyze bujunggans included in a single junggan. In particular, the analyzer 202 may analyze a number of bujunggans included in a single junggan. The analyzer 202 may identify disposition of bujunggans included in a single junggan. In this instance, bujunggans may be disposed in a single junggan through first to thirteenth disposition methods. The disposition methods will be described with reference to FIG. 3.

The generator 203 may generate jungganbo structure data describing the structure of the jungganbo, based on a result of the analyzing. In particular, the generator 203 may generate the jungganbo structure data based on the gaks, the daegangs, and the junggans included in the jungganbo, and symbols and a structure of bujunggans included in junggans. Here, the jungganbo structure data may include basic information of the jungganbo, structure information of the jungganbo, structure information of the junggans, and writing information of the bujunggans. The jungganbo structure data may correspond to XML data, and include data to be used for converting the jungganbo to a digital file.

The generator 203 may include the basic information of the jungganbo based on basic information of a score written by a jungganbo. The basic information of the jungganbo will be described by referring to the following Table 1.

```
TABLE 1
<!ELEMENT scaling (millimeters, tenths)>
  <!ELEMENT millimeters (#PCDATA)>
  <!ELEMENT tenths %layout-tenths;>
<!ELEMENT page-layout ((page-height, page-width)?, (page-margins,
page-margins?)?)>
  <!ELEMENT page-height %layout-tenths;>
  <!ELEMENT page-width %layout-tenths;>
  <!ELEMENT page-margins (left-margin, right-margin, top-margin,
bottom-margin)>
    <!ATTLIST page-margins
      type (odd | even | both) #IMPLIED>
    <!ELEMENT left-margin %layout-tenths;>
    <!ELEMENT right-margin %layout-tenths;>
    <!ELEMENT top-margin %layout-tenths;>
    <!ELEMENT bottom-margin %layout-tenths;>
<!ELEMENT page (title-layout,gak-attribute)>
  <!ELEMENT title-layout (work-title?, upper-title?, small-title?)>
  <!ELEMENT work-title (work-title-width, work-title-content?,
  overall-speed?)>
      <!ELEMENT work-title-width %layout-tenths;>
      <!ELEMENT work-title-content (#PCDATA)>
      <!ELEMENT overall-speed EMPTY>
        <!ATTLIST overall-speed
          speed CDATA #IMPLIED>
    <!ELEMENT upper-title (upper-title-height, upper-title-content?)>
      <!ELEMENT upper-title-height %layout-tenths;>
      <!ELEMENT upper-title-content (#PCDATA)>
    <!ELEMENT small-title (small-title-width, small-title-content?)>
      <!ELEMENT small-title-width %layout-tenths;>
      <!ELEMENT small-title-content (#PCDATA)>
```

The basic information of the jungganbo may correspond to information described in an XML. The basic information of the jungganbo may include basic information to be used for converting the jungganbo to a digital file. The basic information of the jungganbo may include information on a width, a height, and top, bottom, left, and right margins of a score for a layout of the score written on a jungganbo. Here, the top, bottom, left, and right margins may be defined in a form of type (odd|even|both).

The basic information of the jungganbo may include contents on a title, a subtitle, a composer, and the like of a score so that a plurality of scores written on jungganbos may be distinguished. In this instance, the basic information of the jungganbo may consider a width and an area for each piece of information in order to layout information of the title, the subtitle, and the composer. For example, the basic information of the jungganbo may consider a width and an area of information on a corresponding title, a subtitle, and a composer so that the title, the subtitle, and the composer may be displayed, on a score to be laid out in the structure of the jungganbo, to correspond to a width and an area of a cell in which the information on the title, the subtitle, and the composer is displayed.

In particular, the basic information of the jungganbo may include information to be used for managing a basic frame of a score to be laid out when the jungganbo is restored.

The generator 203 may include the structure information of the jungganbo. The structure information of the jungganbo will be described in detail by referring to Table 2.

```
TABLE 2
<!ELEMENT gak-attribute (gang-width, jung-height,number-of-gaks,
gangs)>
    <!ELEMENT gang-width %layout-tenths;>
    <!ELEMENT jung-height %layout-tenths;>
    <!ELEMENT number-of-gaks (#PCDATA)>
    <!ELEMENT gangs (the-gang+)>
    <!ATTLIST gangs
        number CDATA #REQUIRED>
      <!ELEMENT the-gang (#PCDATA)>
        <!ATTLIST the-gang
        gang-index CDATA #REQUIRED>
<!ELEMENT jangdan-exist EMPTY>
  <!ATTLIST jangdan-exist
        existence (0|1) #REQUIRED>
<!ELEMENT credit (credit-words)>
  <!ELEMENT credit-words (#PCDATA)>
  <!ELEMENT part-list ( score-part*)>
    <!ELEMENT score-part (part-name, instrument-name)>
      <!ATTLIST score-part
        id ID #REQUIRED>
      <!ELEMENT part-name (#PCDATA)>
        <!ATTLIST part-name>
    <!ELEMENT instrument-name (#PCDATA)>
```

The structure information of the jungganbo may correspond to information described in an XML. The structure information of the jungganbo may include information on the gaks, the daegangs, and the junggans constituting the jungganbo. The structure of the jungganbo may be divided into gaks, daegangs, and junggans, and many junggans constitute a daegang, and at least one daegang constitutes a gak. Here, a junggan is a basic unit of the jungganbo.

The structure information of the jungganbo may include a number of the gaks, a number of the daegangs, and a number of the junggans, in order to construct the jungganbo. The structure information of the jungganbo may include a number of daegangs constituting a single gak, and a number of junggans constituting each daegang. Each junggan included in each daegang may have an empty value which does not include a garbage value. In addition, the structure information of the jungganbo may be defined by a different number of gaks, a different number of daegangs, and a different number of junggans for each score written on a jungganbo, in particular, for each piece of music.

The generator 203 may include the structure information of the junggans. The structure information of the junggans will be described in detail by referring to Table 3.

```
TABLE 3
<!ELEMENT part (gak+)>
  <!ATTLIST part
    id IDREF #REQUIRED >
  <!ELEMENT gak (gak-description*, gang*)>
    <!ATTLIST gak
                          number CDATA #REQUIRED>
    <!ELEMENT gak-description (#PCDATA)>
    <!ELEMENT gang (jung*)>
    <!ATTLIST gang
                              number CDATA #REQUIRED>
    <!ELEMENT jung (%music-data;)>
      <!ATTLIST jung
                              number CDATA #REQUIRED
                              sumpyo %yes-no; #IMPLIED
          banbokpyo %start-stop; #IMPLIED
          barline (single|double|bold-double) “single”>
      <!ELEMENT attributes (division-case)>
        <!ELEMENT division-case (#PCDATA)>
```

The structure information of the junggans may correspond to information described in an XML. The structure information of the junggans may include a basic structure of junggans corresponding to basic units of a jungganbo.

A single junggan may include at least one bujunggan. Here, a single junggan may be divided into multiple areas to express shorter sounds. A divided single area may be referred to as a bujunggan. The single junggan may be expressed in thirteen different forms, depending on a method of dividing the junggan.

Accordingly, the structure information of the junggans may include a sumpyo, a banbokpyo, and a barline that may be included in a single junggan, in correspondence to a single junggan existing in a daegang included in a single gak. The structure information of the junggans may be used to verify a bujunggan division type that may divide a single junggan. For example, the structure information of the jungganbo may include “division_type” selected based on the thirteen forms in which a single junggan is divided. The structure information of the junggans may be expressed by “division_case” selected in a form of first to thirteenth forms of bujunggans, based on “division_type”.

The generator 203 may include the writing information of the bujunggans. The writing information of the bujunggans will be described in detail by referring to Table 4.

TABLE 4

```
<!ELEMENT note ((rest| pitch | jangdan | jangsikbuho | expression
sign1 )?,
            expression sign2?, jangsikum?, jubeop?, lyric?)>
      <!ELEMENT rest ANY>
    <!ELEMENT pitch (step, octave)>
        <!ELEMENT step (#PCDATA)>
        <!ELEMENT octave (#PCDATA)>
      <!ELEMENT jangsikum (#PCDATA)>
    <!ELEMENT expression sign1 (#PCDATA)>
      <!ELEMENT expression sign2 (#PCDATA)>
    <!ELEMENT jangdan ANY>
        <!ATTLIST jangdan
          name (dung | deok | kung | deorrr | gideok |
            deo | gu | gugung | gugugung | guk) #IMPLIED >
      <!ELEMENT jangsikbuho (#PCDATA)>
      <!ELEMENT jubeop (#PCDATA)>
      <!ELEMENT lyric (text)>
          <!ATTLIST lyric >
            <!ELEMENT text (#PCDATA)>
            <!ATTLIST text
              xml:lang NMTOKEN #IMPLIED >
```

The writing information of the bujunggans may correspond to information described in an XML. The writing information of the bujunggans may include a symbol and a yulmyung that may express sounds of the jungganbo. The yulmyung refers to a pitch of sound, and may be written in a letter. In general, there are twelve yulmyungs written in twelve letters. The twelve yulmyungs may express a main octave, two octaves lower than the main octave, and two octaves higher than the main octave. The twelve yulmyungs used in jungganbo are shown in Table 5.

TABLE 5

| | | |
|---|---|---|
| Jungchungsung | [symbol] | [symbol] |
| (2 octaves higher) | | |
| Chungsung | [symbol] | [symbol] |
| (1 octave higher) | | |
| Jungsung or Jungsung | [symbol] | [symbol] |
| Taksung | [symbol] | [symbol] |
| (1 octave lower) | | |
| Baetaksung | [symbol] | [symbol] |
| (2 octaves lower) | | |

A single bujunggan divided from a single junggan may include a yulmyung and a symbol. The symbol included in the bujunggan may be described and divided by a jangsikbuho, a jangsikum, an expression sign, and a jubeop. The jubeop may include a left hand jubeop, a right hand jubeop, and an unjibeop. In general, the expression sign is written next to a yulmyung to modify the yulmyung. The expression sign may include a symbol written in lieu of a yulmyung, similar to the jangsikbuho.

The writing information of the bujunggans may classify the expression sign into two types depending on an expression method, in view of attributes of the expression sign. A first expression sign refers to an expression sign written in lieu of a yulmyung, and a second expression sign refers to an expression sign written next to a yulmyung.

The apparatus 201 for describing a jungganbo score may analyze a basic structure of a jungganbo with respect to gaks, daegangs, and junggans constituting the jungganbo, and generate XML-based jungganbo structure data, thereby effectively digitalizing the jungganbo with a corrected compatibility among score writing programs.

In addition, the apparatus 201 for describing a jungganbo may store a jungganbo as a digital file using an XML. In particular, the apparatus 201 for describing a jungganbo may refer to a document type definition (DTD) based apparatus for describing a jungganbo that may analyze a structure of the jungganbo, classify symbols to be utilized for writing the jungganbo, and include various symbols and structures of the jungganbo based on the analysis on usage of the symbols.

FIG. 3 is a block diagram illustrating an apparatus 301 for restoring a jungganbo according to an embodiment of the present invention.

Referring to FIG. 3, the apparatus 301 for restoring a jungganbo may include an identifier 302 and a restorer 303.

The identifier 302 may identify a structure of a jungganbo by analyzing jungganbo structure data describing the structure of the jungganbo. In particular, the identifier 302 may interpret the jungganbo structure data described in an XML, and identify the structure of the jungganbo included in the jungganbo structure data. In this instance, the identifier 302 may interpret the jungganbo structure data in which the jungganbo is described, through an XML interpreting program. For example, the identifier 302 may identify the structure of the jungganbo including gaks, daegangs, and junggans included in the jungganbo structure data, by analyzing the jungganbo structure data using the XML interpreting program. In addition, the identifier 302 may identify the structure of the jungganbo, including bujunggans included in a junggan, and symbols or yulmyungs included in the bujunggans.

The restorer 303 may restore the jungganbo based on the structure of the jungganbo identified by the identifier 302. In this example, the restorer 303 may restore the jungganbo based on the structure of the jungganbo corresponding to the jungganbo structure data including basic information of the jungganbo, structure information of the jungganbo, structure information of the junggans, and writing information of the bujunggans.

The jungganbo restored based on the structure of the jungganbo is shown in Table 6.

As shown in Table 6, it may be understood that the restored jungganbo has the same structure as a typical jungganbo. In particular, the restored jungganbo may describe, in an XML, the structure of the jungganbo through an apparatus for describing a jungganbo, and the jungganbo structure data described in XML may be expressed accurately in a form of the jungganbo.

In addition, the apparatus 301 for restoring a jungganbo may interpret the jungganbo structure data described according to DTD suggesting a score written on a jungganbo and express the jungganbo structure data as the jungganbo. Accordingly, the described jungganbo may be properly interpreted and shown in the form of the jungganbo.

FIG. 4 is a diagram illustrating bujunggans according to an embodiment of the present invention.

Referring to FIG. 4, a jungganbo may express sounds of the jungganbo using a length of sound expressed in a single junggan. In addition, the jungganbo may express a shorter length of sound than the junggan, using a bujunggan corresponding to a single area divided from a single junggan.

Here, in a method of using a bujunggan, a single junggan may have a length equal to a quarter note. In this example, a single junggan may be divided into two bujunggans. A length of one of the two bujunggans may correspond to a length of half of a quarter note. In addition, when a single junggan is divided into multiple bujunggans, a length of sound expressed by each bujunggan may be expressed as shown in FIG. 4.

In general, a single junggan may be divided into columns and rows. For example, a single junggan may be divided into two columns and three rows. In particular, a single to junggan may be divided into six bujunggans at a maximum. In this example, a length of a single bujunggan may be ⅙ of a length of a single junggan. In addition, in view of a number of cases of a single junggan being divided, a single junggan may be divided into thirteen different forms as shown in a diagram 400 of FIG. 4.

FIG. 5 is a flowchart illustrating a method of describing a jungganbo according to an embodiment of the present invention.

Referring to FIG. 5, in operation 501, an apparatus for describing a jungganbo may analyze a structure of the jungganbo based on gaks, daegangs, and junggans constituting the jungganbo. In particular, the apparatus for describing a jungganbo may analyze the structure of the jungganbo to describe the jungganbo in an XML according to the aforementioned DTD.

In operation 502, the apparatus for describing a jungganbo may generate jungganbo structure data describing the structure of the jungganbo, based on a result of the analyzing. The jungganbo structure data will be described in detail by referring to Table 7. Table 7 includes a portion of a result of describing the jungganbo in an XML.

```
TABLE 7
<gak-attribute>
    <gang-width>33</gang-width>
    <jung-height>15</jung-height>
    <number-of-gaks>8 </number-of-gaks>
        <gangs number=“4”>
                        <the-gang gang-index=“1”>3</the-gang>
                        <the-gang gang-index=“2”>3</the-gang>
                        <the-gang gang-index=“3”>3</the-gang>
        <the-gang gang-index=“4”>3</the-gang>
        </gangs>
</gak-attribute>
```

In Table 7, the apparatus for describing a jungganbo may include gaks, daegangs, and junggans constituting the jungganbo, as the result of describing the structure of the jungganbo in an XML.

In this example, a number of the gaks may be set to “8”. In particular, the number of the gaks in the XML may be preset to “8”. A number of daegangs included in each gak may be set to “4”. Each daegang may include a unique index, and include three junggans. The apparatus for describing a jungganbo may generate jungganbo structure data including basic information of the jungganbo and structure information o the jungganbo, as most basic to information of the jungganbo, through the XML written in Table 7.

The apparatus for describing a jungganbo may generate the jungganbo structure data including structure information of the junggans and writing information of the bujunggans, using Table 8.

TABLE 8

```
<part id=“P1”>
  <gak number=“1”>
    <gang number=“1”>
        <jung barline=“single” number=“1” sumpyo=“no”>
          <attributes>
              <division-case>1</division-case>
            </attributes>
            <note>
                <pitch>
                  <step>IM</step>
                  <octave>5</octave>
                </pitch>
                <jangsikum>NIRE</jangsikum>
            </note>
        </jung>
        <jung barline=“single” number=“2” sumpyo=“no”>
            <attributes>
                <division-case>2</division-case>
            </attributes>
            <note>
              <pyobuho1>YEONEUMPYO</pyobuho1>
            </note>
            <note>
              <jangsikbuho>NI</jangsikbuho>
            </note>
        </jung>
        <jung barline=“single” number=“3” sumpyo=“no”>
            <attributes>
                <division-case>1</division-case>
            </attributes>
            <note>
                <pitch>
                    <step>JUNG</step>
                    <octave>5</octave>
                </pitch>
              </note>
        </jung>
</gang>
```

In Table 8, a portion with respect to daegangs of a first index of a first gak may be written. When “division-case” of a first junggan included in the first index is set to “1”, a bujunggan of the first junggan may be “1”. The bujunggan may be expressed using <node> included in a single junggan. In particular, when “division-case” of the first junggan is set to “1”, a single <node> may express a bujunggan. The node may include a symbol or a yulmyung that may express the jungganbo. For example, with respect to a yulmyung “IM” written in a junggan, the node may describe “IM”, a name of yulmyung used in a node, and octave information, in the node. In addition, the node may describe “NIRE” written as a jangsikum next to the yulmyung written in the jungganbo, in a cell corresponding to “jangsikum” in the node.

When “division-case” of a second junggan included in the first index is set to “2”, the bujunggan of the first junggan may be “2”. When “division-case” of the first junggan is set to “2”, two <node>s may express bujunggans. Symbols yulmyungs included in the node may be used to correspond to names defined in the XML. For example, a fermata sign as an expression sign expressed in the first bujunggan may be a sign expressed in lieu of a yulmyung, among expression signs, and may be described in “expression sign1” in the XML. As another example, “NI” as a jangsikbuho expressed in the second bujunggan may be described in “jangsikbuho” in the XML.

In addition, yulmyungs and octaves may be described in a similar form as though “division-case” is set to “1”.

FIG. 6 is a flowchart a method of restoring a jungganbo according to an embodiment of the present invention.

Referring to FIG. 6, in operation 601, an apparatus for restoring a jungganbo may identify a structure of the jungganbo by analyzing jungganbo structure data describing the structure of the jungganbo. The apparatus for restoring a jungganbo may interpret the jungganbo structure data described in an XML, and identify the structure of the jungganbo included in the jungganbo structure data, with respect to gaks, daegangs, junggans, bujunggans included in a single junggan, and yulmyungs or symbols included in bujunggans, included in the jungganbo structure data.

In operation 602, the apparatus for restoring a jungganbo may restore the jungganbo based on the structure of the jungganbo identified based on basic information of the jungganbo, structure information of the jungganbo, structure information of the junggans, and writing information of the bujunggans included in the jungganbo structure data.

The apparatus for restoring a jungganbo may interpret and restore jungganbo structure data described in XML according to DTD for describing a jungganbo, thereby invigorating various types of jungganbos described based on DTD.

The methods according to the exemplary embodiments of the present invention may be recorded in computer-readable media including program instructions to implement various operations embodied by a computer. The media may also include, alone or in combination with the program instructions, data files, data structures, and the like. The program instructions recorded on the media may be those specially designed and constructed, or they may be of the kind well-known and available to those having skill in the computer software arts.

According to an embodiment of the present invention, a method of describing a jungganbo may store, in a digital file format, the jungganbo including various symbols expressing sounds of the jungganbo and a structure of gaks, daegangs, and jungs constituting the jungganbo, thereby describing the jungganbo using less capacity and enabling the jungganbo to be utilized in various environments.

According to another embodiment of the present invention, a method of describing a jungganbo may include various types of symbols and structures of the jungganbo, by analyzing the symbols and the structures of the jungganbo to store the jungganbo as a digital file using an XML.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of describing a jungganbo, the method comprising:
analyzing a structure of the jungganbo based on gaks, daegangs, and junggans constituting the jungganbo; and
generating jungganbo structure data describing the structure of the jungganbo, based on a result of the analyzing.

2. The method of claim 1, wherein the jungganbo structure data is described in an extensible markup language (XML).

3. The method of claim 1, wherein the jungganbo structure data comprises at least one of basic information of the jungganbo, structure information of the jungganbo, structure information the junggans, and writing information of bujunggans.

4. The method of claim 3, wherein:
the basic information of the jungganbo comprises at least one of a width, a height, and top, bottom, left, and right margins of a score for a layout of the score written on a jungganbo, and
a width and a height of a space in which at least one of a title, a subtitle, and a composer of the jungganbo is to be written are considered.

5. The method of claim 3, wherein:
the structure information of the jungganbo comprises a number of the daegangs, a number of the junggans, a number of the gaks comprising the daegangs and the junggans, and indices to be used for identifying the daegangs respectively, and
the junggans do not include contents for expressing the jungganbo.

6. The method of claim 3, wherein the structure information of the junggans comprises a structure or a number of the bujunggans to be used for dividing the junggans to express shorter sounds.

7. The method of claim 3, wherein the writing information of the bujunggans comprises at least one of a first expression sign to be written in lieu of a yulmyung using a rest, a pitch, a jangdan, and a jangsikbuho, and a second expression sign to be written next to the yulmyung using a jangsikum, a jubeop, and lyrics.

8. A method of restoring a jungganbo, the method comprising:
identifying a structure of the jungganbo by analyzing jungganbo structure data describing the structure of the jungganbo; and
restoring the jungganbo based on the identified structure of the jungganbo,
wherein the jungganbo structure data expresses a structure of gaks, daegangs, and junggans constituting the jungganbo.

9. An apparatus for describing a jungganbo, the apparatus comprising:
an analyzer to analyze a structure of the jungganbo based on gaks, daegangs, and junggans constituting the jungganbo; and
a generator to generate jungganbo structure data describing the structure of the jungganbo, based on a result of the analyzing.

10. The apparatus of claim 9, wherein the jungganbo structure data is described in an extensible markup language (XML), and comprises at least one of basic information of the jungganbo, structure information of the jungganbo, structure information the junggans, and writing information of bujunggans.

11. An apparatus for restoring a jungganbo, the apparatus comprising:
an identifier to identify a structure of the jungganbo by analyzing jungganbo structure data describing the structure of the jungganbo; and
a restorer to restore the jungganbo based on the identified structure of the jungganbo,
wherein the jungganbo structure data expresses a structure of gaks, daegangs, and junggans constituting the jungganbo.
